(19) United States
(12) Patent Application Publication
(10) Pub. No.: US 2005/0098005 A1
(43) Pub. Date: May 12, 2005

(54) Method and apparatus for cutting metal structural members

(76) Inventor: Leon B. Trudeau, Winnipeg (CA)

Correspondence Address: STITES & HARBISON PLLC, 1199 NORTH FAIRFAX STREET, SUITE 900, ALEXANDRIA, VA, 22314, US

(21) Appl. No.: 10/702,581

(22) Filed: Nov. 7, 2003

(51) Int. Cl. B26D 1/06

(52) U.S. Cl. 83/54; 83/679

(57) ABSTRACT

An elongate metal structural member is cut off transversely of the member by engaging one side of the member with a beveled cutting edge of a blade, supporting the member on a side opposite the blade, at support positions spaced from respective opposite sides of the median plane of the blade and forcing the blade through the member. The cutting edge is symmetrical in cross section about a median plane of the blade. The structural member may be an ungrouted, hollow, tubular member, for example a support pile for a deep sea drilling or production platform. The cutting edge may be supplemented by two secondary beveled cutting edges transverse to the primary cutting edge for engaging sides of the tubular member to cut lateral bulges that may be formed by flattening of the member as it is pressed between the primary cutting edge and the support.

### FIELD OF THE INVENTION

The present invention relates to the cutting off or truncation of elongate metal structural members.

### BACKGROUND

In various industries, it is necessary to truncate structural members, either trimming them to a desired length, or removing unwanted material. In the off-shore petroleum industry, for example, for the decommissioning of drilling and production platforms, it is of importance to remove the support legs or pilings as close to the sea bed as possible. Conventionally, this involves the use of divers working with thermal cutting tools, explosives or both. The conventional procedures are time consuming and costly.

The truncation of concrete piles is known using cutters as described in commonly owned U.S. Pat. Nos. 5,319,006 and 5,413,086, the entire disclosures of which are incorporated herein by reference. European patent application 243,981 discloses a cutter for concrete piles which may include steel cylinders grouted with the concrete and used as off-shore platform piles. The known concrete cutters are not, however suitable for cutting metal structural members, including ungrouted tubular members, wide flange beams and other shapes. It has been found that the blades used for concrete will not stand up to the stresses encountered in cutting off metal members. In addition, the force pressing the blade into the member may cause the structural member to deform and collapse rather than cutting completely through. Where the parts are not completely severed, there is a “snag”, the remaining connection between the parts, preventing their free separation. This is particularly noticeable with hollow tubular members.

The present invention aims at the provision of a cutter that is capable of truncating elongate structural members of various configurations and materials, including metal hollow members, whether grouted or not.

### SUMMARY

According to one aspect of the present invention there is provided a method for cutting off an elongate structural member transversely of the member, said method comprising:
engaging one side of the member with a beveled cutting edge of a blade, the cutting edge being symmetrical in cross section about a median plane of the blade;
supporting the member on a side opposite the blade; and
forcing the blade through the member.

Preferably the member is supported at support positions spaced from respective opposite sides of the median plane of the blade, leaving a pocket between the support positions into which the blade may penetrate to ensure a complete severing of the member.

According to another aspect of the present invention there is provided a cutting tool for cutting off an elongate metal structural member transversely of the member, said tool comprising:
a blade having a beveled cutting edge for engaging one side of the structural member, the cutting edge being symmetrical in cross section about a median plane of the blade;
a support for supporting the structural member on a side opposite the blade; and
a blade driver for forcing the blade through the member.

Preferably the support has two spaced apart components for supporting the structural member at support positions on respective opposite sides of the blade.

The symmetrical blade has been found to resist the stresses encountered in cutting metal structural members. The cutting edge is preferably defined by the intersection of two surfaces meeting at an included angle not less than 45°. This is preferably backed by a secondary bevel of smaller angle, for example 17°. The combination yields an overall bevel that is only slightly greater in depth than the thickness of the blade, for example a 3 inch depth for a blade thickness of 2.5 inches. Existing concrete cutters have a bevel depth of approximately 10 inches for a 2.5 inch blade thickness. In use, the cutter tips upwardly at the rear and when cutting metal, the long bevel has a tendency to bend, severely restricting the life of the blade.

Where the structural member is an ungrouted, hollow, tubular member, the cutting edge may be used as a primary cutting edge supplemented by two secondary beveled cutting edges transverse to the primary cutting edge, and for engaging the tubular member therebetween to score lateral bulges that may be formed by flattening of the member as it is pressed between the primary cutting edge and the support. The secondary cutting edges are preferably formed on the blade.

### BRIEF DESCRIPTION OF THE DRAWINGS

In the accompanying drawings, which illustrate exemplary embodiments of the present invention:

FIG. 1 is a plan view of a cutting tool according to the present invention;

FIG. 2 is a section along line 2-2 of FIG. 1;

FIG. 3 is a section along line 3-3 of FIG. 1;

FIG. 4 is a section along line 4-4 of FIG. 1;

FIG. 5 is a plan view of a first embodiment of the blade;

FIG. 6 is a plan view of a second embodiment of the blade; and

FIG. 7 is a illustration of the deformation of a hollow, cylindrical member between the primary cutting edge and the support.

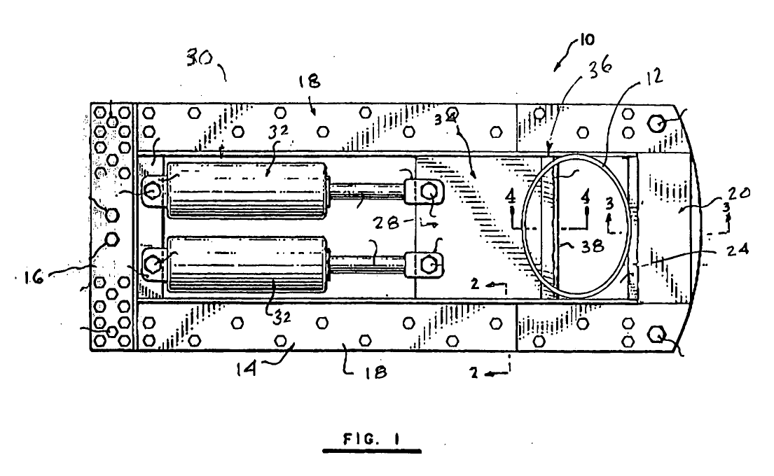

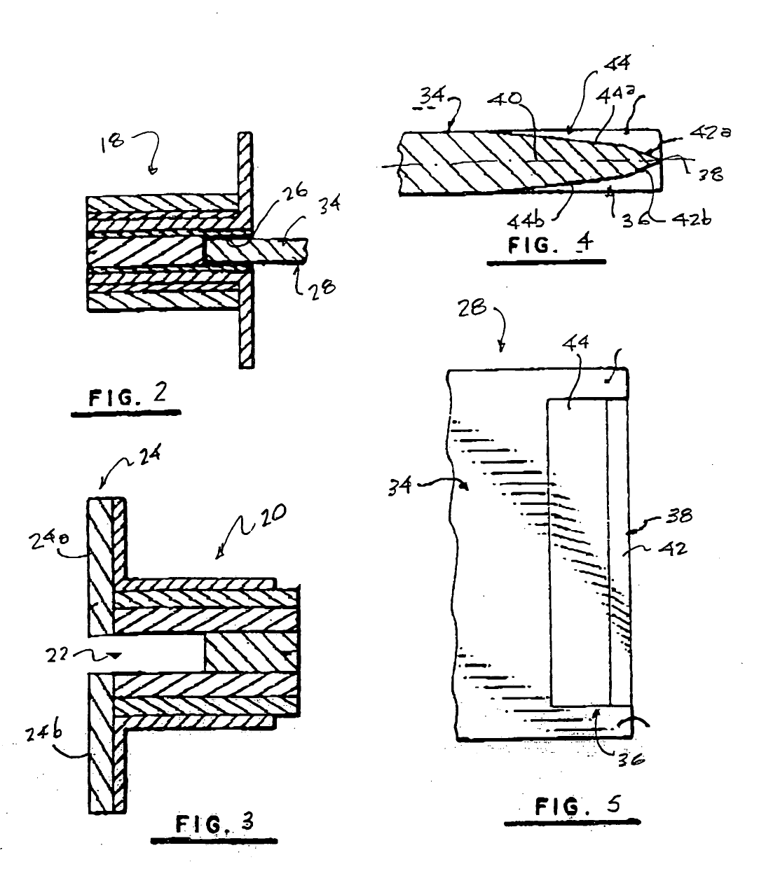

### DETAILED DESCRIPTION

Referring to the accompanying drawings, there is illustrated a cutting tool 10 for cutting off an elongate structural member, in this embodiment a hollow cylindrical metal member 12.

The tool includes a frame 14 including a rear cross member 16, two side rails 18 and an end gate 20. The frame is constructed generally as described in U.S. Pat. No. 5,139,006, the disclosure of which has been incorporated herein, as noted above. In this frame, however, the end gate 20 has a lateral pocket 22 extending the width of the frame, between respective components 24a and 24b of a support 24.

The side rails 18 have inwardly facing channels 26 (FIG. 2) which accommodate the edges of a blade 28 that slides along the rails towards and away from the end gate under the control of a blade driver 30 including, in this embodiment, two hydraulic cylinders 32.

The blade 28 is a flat steel plate 34 with a double bevel 36 along the cutting edge 38. The bevel 36 is symmetrical about a median plane 40. The cutting edge 38 is defined by the intersection of two surfaces 42a and 42b meeting at an included angle of approximately 50°, and not less than 45°. The secondary, backing bevel 44 is defined by two surfaces 44a and 44b having an included angle of approximately 34°. The result is a combined bevel depth of 3 inches for a plate thickness of 2.5 inches.

In use of this tool, the structural member 12 is positioned between the blade 28 and the support 24 on the end gate 20. The cylinders 32 are actuated to drive the cutting edge 38 into and through the member 12, into the pocket 22 between the support components 24a and 24b. this provides a complete severing of the member with no snags.

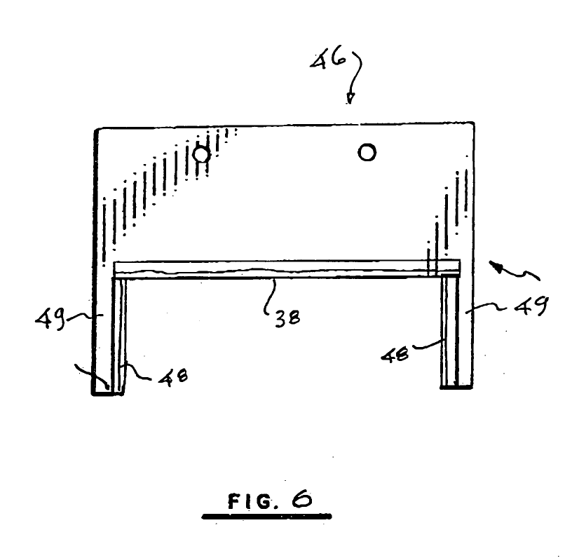

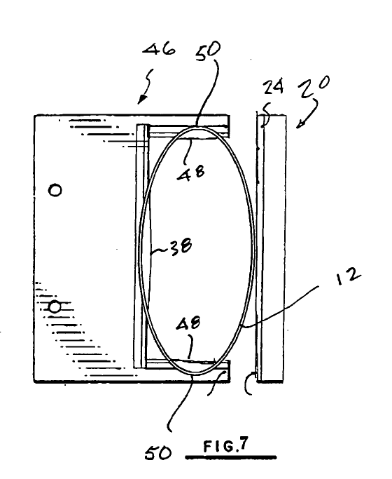

An alternative embodiment of the blade 46 is illustrated in FIGS. 6 and 7. This blade 46 is intended for cutting those members that are subject to lateral deformation when driven against the support by the blade. This is of particular concern with smaller diameter hollow tubular members where there is significant clearance between the undeformed member and the side rails of the frame. To deal with this, the cutting edge 38 of the blade is recessed from the leading edge of the blade plate, and two secondary cutting edges 48 are formed on the “ears” 49 of the blade that project forwardly from the cutting edge 38. The secondary cutting edges are similar in cross-sectional configuration to the primary cutting edge 38 (FIG. 4). They are oriented transversely to the primary cutting edge and confront one another for engaging the member to be cut therebetween, to provide an additional cutting or scoring of laterally distended parts 50 of the member 12 formed as the member is flattened between the blade and the support 24. These cutting edges 48 to ensure a complete cutting through of the member with no snags.

While particular embodiments of the present invention have been described in the foregoing, it is to be understood that other embodiments are possible within the scope of the invention. It is also to be understood that the invention is not limited to use in cutting hollow cylindrical members, but is useful for cutting off structural members of most any form, including tubes of any cross section: circular, square or other polygonal, whether hollow or grouted, and other shapes, for example I beam, Wide Flange or H beam configurations. The invention is therefore to be considered limited solely by the scope of the appended claims.

1. A method for cutting off an elongate structural member transversely of the member, said method comprising:
engaging one side of the member with a beveled cutting edge of a blade, the cutting edge being symmetrical in cross section about a median plane of the blade;
supporting the member on a side opposite the blade; and
forcing the blade through the member.

2. A method according to claim 1 comprising supporting the member at support positions on opposite sides of the blade and forcing the blade through the member and between the support positions.

3. A method according to claim 1 wherein the cutting edge is defined by the intersection of two surfaces meeting at an included angle not less than 45°

4. A method according to claim 1 wherein the structural member is tubular.

5. A method according to claim 4 wherein said cutting edge is a primary cutting edge and further comprising engaging the structural member between two opposing secondary cutting edges transverse to the primary cutting edge.

6. A cutting tool for cutting off an elongate metal structural member transversely of the member, said tool comprising:
a support for supporting one side of the structural member;
a blade having a beveled cutting edge for engaging the member on a side opposite the support, the cutting edge being symmetrical in cross section about a median plane of the blade; and
a blade driver for forcing the blade through the member.

7. A tool according to claim 6 wherein the support comprises two spaced apart components for supporting the structural member at support positions on respective opposite sides of the blade.

8. A tool according to claim 6 wherein the cutting edge is defined by the intersection of two surfaces meeting at an included angle not less than 45°

9. A tool according to claim 6 wherein the structural member is tubular.

10. A tool according to claim 9 wherein said cutting edge is a primary cutting edge and further comprising two secondary beveled cutting edges transverse to the primary cutting edge and for engaging the tubular member therebetween.

11. A tool according to claim 10 wherein the secondary cutting edges are immovable with respect to the primary cutting edge.

12. A tool according to claim 11 wherein the secondary cutting edges are formed on the blade.

13. A tool according to claim 6 including a frame mounting the support and the blade for movement of the blade and the support surface toward and away from one another.

14. A tool according to claim 13 wherein the frame includes guides supporting opposite sides of the blade for guiding movement of the blade towards and away from the support surface.

15. A tool according to claim 6 wherein the blade driver comprises one or more hydraulic cylinders.

16. A tool according to claim 6 wherein the support comprises a pocket for engaging and centering the member.
